(19) United States
(12) Patent Application Publication
(10) Pub. No.: US 2014/0051496 A1
(43) Pub. Date: Feb. 20, 2014

(54) Electronic Gaming Machine and Gaming Method

(71) Applicant: AINSWORTH GAME TECHNOLOGY LIMITED, Newington (AU)

(72) Inventor: Jason Meyer, Abbotsford (AU)

(73) Assignee: Ainsworth Game Technology Limited, Newington (AU)

(21) Appl. No.: 13/793,283

(22) Filed: Mar. 11, 2013

(30) Foreign Application Priority Data
Aug. 15, 2012 (AU) 2012903516

(51) Int. Cl. G07F 17/32

(52) U.S. Cl. CPC G07F 17/3267
USPC 463/21; 463/20

(57) ABSTRACT

An electronic gaming machine has special symbols associated with numerical values appearing on a display in a game are associated with predetermined portions of an array for subsequent plays of the game. Predetermined winning combinations including a designated game symbol in one of the predetermined portions may increase the value of the prize by the numerical value associated with the special symbol. Where two special symbols appear in the same predetermined portion, the prize value may increase by a combination of the numerical values associated with the special symbols. Gaming methods are also provided.

### BACKGROUND

The present invention relates to an electronic gaming machine and in a particular an electronic gaming machine using a base game and a feature game. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may be provided by an electronic gaming machine in addition to the base or main game. Typically feature games use the same set of reels as the main game and are limited to a set of free games operated under a single set of rules. Once the free feature games have been played, the electronic gaming machine resets itself and returns the player back to the base game. This standard structure to game play limits the variation in the play of the electronic gaming machine. Consequently, it is difficult to retain player interest because there is no apparent incentive for the player to continue playing the same electronic gaming machine once the player becomes familiar with the feature game and the main game. Also, it is difficult to retain player interest since there is little differentiation between gaming machines in terms of the main and feature games that are played.

It is an object of the present invention to overcome or substantially ameliorate one or more of the disadvantages of prior art, or at least to provide a useful alternative.

It is an object of the invention in at least one preferred form to provide an electronic gaming machine and a method for controlling an electronic gaming machine that encourages player interest.

### SUMMARY

According to a first aspect of the invention, there is provided an electronic gaming machine comprising:

a display for displaying game symbols for playing a game, where predetermined winning combinations of randomly selected game symbols award prizes to a player and said game symbols are arranged into an array, and

an electronic game controller for controlling the display of game symbols on the display,

wherein said electronic game controller determines the appearance of one or more special symbols in said game, said special symbols being associated with a numerical value, and

wherein the appearance of a first special symbol in a first play of said game causes said electronic game controller to associate said first special symbol with a predetermined portion of said array for one or more subsequent plays of said game such that said electronic game controller increases the value of any prize awarded upon a predetermined winning combination appearing in said one or more subsequent plays, said predetermined winning combination comprising a designated game symbol in said predetermined portion, said increase being associated with the numerical value associated with said first special symbol.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Preferably, said designated game symbol comprises one of said game symbols. More preferably, said designated game symbol comprises one of said special symbols. In one preferred form, said designated game symbol comprises a wild symbol. In another preferred form, said designated game symbol may also act as at least one of a replacement symbol, a wild card symbol, a scatter symbol, bonus prizes, collector symbols, a win multiplier, wild multipliers, bonus wilds, random wild symbols, progressive symbols, bonus credits and jackpot symbols.

Preferably, said first special symbol appears in said predetermined portion in said first play.

Preferably, said increase is a multiple of said numerical value associated with said first special symbol.

Preferably, the appearance of a second special symbol in said first play causes said electronic game controller to associate said second special symbol with a second predetermined portion for said subsequent plays such that said prize is increased where said predetermined winning combination comprises said designated symbol appearing in said second predetermined portion, said increase being associated with a combined value of the numerical values associated with said first and second special symbols. More preferably, said increase is a multiple of said combined value. In one preferred form, said combined value is the sum of said numerical values associated with said first and second special symbols. Alternatively, said combined value is the multiplication of said numerical values associated with said first and second special symbols.

Preferably, said second predetermined portion is the same as said predetermined portion. Alternatively, said second predetermined portion is different to said predetermined portion.

Preferably, where a third special symbol appears in said predetermined portion in said first play, said numerical values associated with said third special symbol and said first special symbol are combined into a new combined value that is associated with said predetermined portion and said increase is a multiple of said new combined value. More preferably, said new combined value is associated with a new special symbol that is selectable for appearing in said array for said subsequent plays of said game. In one preferred form, said new combined value is the sum of said numerical values associated with said first and third special symbols. Alternatively, said new combined value is the multiplication of said numerical values associated with said first and third special symbols.

Preferably, said game symbols are arranged in an array of predetermined columns. More preferably, said predetermined portion comprises a first column of said predetermined columns. Alternatively, said predetermined portion comprises a first row of game symbols.

Preferably, said second predetermined portion comprises a second column of said predetermined columns. Alternatively, said second predetermined portion comprises a second row of game symbols.

Preferably, said electronic game controller randomly determines the appearance of said special symbols in said game.

Preferably, said predetermined portion displays a number of game symbols greater than the number of game symbols displayed in at least one other predetermined portion of said array. More preferably, said predetermined portion displays a number of game symbols greater than the number of game symbols displayed in the remaining predetermined portions in said array.

Preferably, the association of said first special symbol with said predetermined portion is indicated on said display during said subsequent plays of said game. More preferably, the association of said second special symbol with said second predetermined portion is indicated on said display during said subsequent plays of said game.

Preferably, said first play and said subsequent plays are consecutive. Alternatively, said first play and said subsequent plays are within a predetermined set of plays of said game.

Preferably, said game comprises a base game and a feature game of said electronic gaming machine, wherein said first play comprises a play of said base game and said subsequent plays comprise plays of said feature game. In this case, said electronic game controller also causes said display to display game symbols for playing a base game, wherein predetermined winning combinations of randomly selected game symbols results in the award of prizes to said player. Alternatively, said game is a base game of said electronic gaming machine. In another alternative, said game is a feature game of said electronic gaming machine.

Preferably, in response to a trigger event, said electronic game controller causes the display of said first special symbol and the association of said first special symbol with said predetermined portion of said array. More preferably, said trigger event comprises said electronic game controller randomly generating a number and determining whether said randomly generated number is a predetermined number or within a predetermined range of numbers.

Alternatively, said trigger event comprises the appearance of at least one trigger symbol in said game. In one preferred form, said trigger event comprises the appearance of three trigger symbols.

Preferably, said trigger event comprises the appearance of at least one trigger symbol in said base game. More preferably, said trigger event causes said display to display game symbols for playing said feature game.

Preferably, said electronic game controller randomly determines the appearance of said at least one trigger symbol. In one preferred form, said at least one trigger symbol is substantially the same symbol as said special symbol.

Preferably, said special symbol may also act as another type of game symbol. More preferably, said special symbol may also act as at least one of a replacement symbol, a wild card symbol, a scatter symbol, bonus prizes, collector symbols, a win multiplier, wild multipliers, bonus wilds, random wild symbols, progressive symbols, bonus credits and jackpot symbols.

Preferably, said electronic game controller awards a random number of plays of said game in response to said trigger event. Alternatively, the number of plays of said game awarded by said electronic game controller in response to said trigger event depends of the amount wagered by the player.

Preferably, the same game symbols are used in said feature game and said base game. Alternatively, different game symbols or a mixture of the same and different game symbols are used in said feature game and said base game.

Preferably, said feature game has the same number of game symbols as said base game. Alternatively, said feature game and said base game have different numbers of game symbols.

Preferably, the game symbols in said feature game and said base game are organised or arranged in the same way. In another preferred form, the game symbols in said feature game and said base game are organised or arranged differently to each other.

Preferably, said game symbols in said feature game and said base game are arranged in arrays of the same shape or type. Alternatively, said game symbols in said feature game and said base game are arranged in differently shaped arrays. The shapes of said arrays are preferably rectangular, circular, triangular, oval, semi-circular or other non-rectangular shape.

Preferably, said electronic game controller causes the display of said feature game and said base game during play of said base game, said feature game being inactive until triggered. In this preferred form, the change in said feature game from being inactive to active may be indicated on the display. Alternatively, said electronic game controller causes the display of said feature game in response to said trigger event.

Preferably, said electronic game controller causes the display of said base game on a separate display to said display. Alternatively, said electronic game controller causes the display of said feature game and said base game on the same display.

According to a second aspect of the invention, there is provided an electronic gaming machine comprising:

a display for displaying game symbols for playing a game, where predetermined winning combinations of randomly selected game symbols award prizes to a player and said game symbols are arranged in an array of predetermined portions, and

an electronic game controller for controlling the display of game symbols on the display,

wherein said electronic game controller determines the appearance of one or more special symbols in said game, said special symbols being associated with a numerical value, and

where at least two special symbols appear in the same predetermined portion, said electronic game controller increases the value of any prize awarded upon a predetermined winning combination comprising a designated game symbol in said same predetermined portion, said increase being associated with a combined value of the numerical values associated with said at least two special symbols.

Preferably, said designated game symbol comprises one of said game symbols. More preferably, said designated game symbol comprises one of said special symbols. In one preferred form, said designated game symbol comprises one of said at least two special symbols. In another preferred form, said designated game symbol comprises a wild symbol. In a further preferred form, said designated game symbol may also act as at least one of a replacement symbol, a wild card symbol, a scatter symbol, bonus prizes, collector symbols, a win multiplier, wild multipliers, bonus wilds, random wild symbols, progressive symbols, bonus credits and jackpot symbols.

Preferably, said increase is a multiple of said combined value.

Preferably, said combined value is displayed on said display. In one preferred form, a new special symbol associated with said combined value becomes selectable for appearing in one or more subsequent plays of said game. More preferably, said new special symbol is associated with said same predetermined portion such that said new special symbol is selectable for appearing in said column in said one or more subsequent plays of said game. It is further preferred that said one or more subsequent plays are consecutive. Alternatively, it is preferred that one or more subsequent plays are within a predetermined set of plays of said game.

Preferably, where said predetermined winning combination comprises at least one additional special symbol in a different predetermined portion to said same predetermined portion, said increase is associated with a combination of said combined value and the numerical value associated with said at least one additional special symbol. More preferably, said increase is a multiple of said combination. In one preferred form, said combination is the sum of said numerical values associated with said at least two special symbols and said at least one additional special symbol. Alternatively, said combination is the multiplication of said numerical values associated with said at least two special symbols and said at least one additional special symbol.

Preferably, said electronic gaming machine also comprises the preferred features of the first aspect of the invention not otherwise stated above, where applicable.

According to a third aspect of the invention, there is provided a gaming method for an electronic gaming machine comprising a display and an electronic game controller, the method comprising the steps of:

controllably displaying game symbols for playing a game, where predetermined winning combinations of randomly selected game symbols in said game results in the award of prizes to a player, said game symbols being arranged in an array;

determining the appearance of one or more special symbols in said game, said special symbols being associated with a numerical value,

associating a first special symbol appearing in a first play of said game with a predetermined portion of said array for one for one or more subsequent plays of said game, and

increasing the value of any prize awarded upon a predetermined winning combination appearing in said one or more subsequent plays, said predetermined winning combination comprising a designated game symbol in said predetermined portion,

wherein said prize value increasing step comprises associating said prize value with the numerical value associated with said first special symbol.

Preferably, said associating step further comprises associating said first special symbol when it appears in said predetermined portion.

Preferably, said prize increasing step further comprises multiplying said prize value by the numerical value associated with said first special symbol.

Preferably, said associating step further comprises associating a second special symbol appearing in said first play with a second predetermined portion for said subsequent plays, and where said predetermined winning combination comprises said designated symbol appearing in said second predetermined portion, said prize value increasing step further comprises the step of combining the numerical values associated with said first and second special symbols to produce a combined value and associating said prize value with said combined value. More preferably, said prize increasing step further comprises multiplying said prize value by said combined value. In one preferred form, said combining step comprises the sum of said numerical values associated with said first and second special symbols. Alternatively, said combining step comprises the multiplication of said numerical values associated with said first and second special symbols.

Preferably, where a third special symbol appears in said predetermined portion in said first play, said prize value increasing step further comprises the step of combining the numerical values associated with said first and third special symbols to produce a new combined value that is associated with said predetermined portion and multiplying said prize by said new combined value. More preferably, said new combined value is the sum of said numerical values associated with said first and third special symbols. Alternatively, said new combined value is the multiplication of said numerical values associated with said first and third special symbols.

Preferably, said determining step comprises randomly determining the appearance of said special symbols in said game.

Preferably, said method further comprises the step of displaying a number of game symbols in said predetermined portion greater than the number of game symbols displayed in at least one portion of said array. More preferably, said displaying step comprises displaying a number of game symbols in said predetermined portion greater than the number of game symbols displayed in the remaining portions of said array.

Preferably, said method further comprises the step of consecutively performing said first play and said subsequent play. Alternatively, said method further comprises the step of performing said first play and said subsequent play within a predetermined set of plays of said game.

Preferably, said method further comprises performing said prize value increasing step in response to a trigger event. More preferably, said trigger event comprises the preferred features of the first aspect of the invention.

Preferably, said game comprises a base game and a feature game of said electronic gaming machine, wherein said first play comprises a play of said base game and said subsequent plays comprise plays of said feature game. More preferably, said method further comprises the step of causing said display to display game symbols for playing a base game, wherein predetermined winning combinations of randomly selected game symbols results in the award of prizes to said player. Alternatively, said game is a main or base game of said electronic

Preferably, said associating step further comprises indicating the association of said first special symbol with said predetermined portion on said display during said subsequent plays of said game. The method also preferably has the other preferred features of the first aspect of the invention.

Preferably, said method comprises the step of awarding a random number of plays of said game in response to said trigger event. Alternatively, the awarding step comprises awarding the number of plays of said game based on the amount wagered by the player.

Preferably, said displaying step comprises displaying said feature game and said base game during play of said base game, said feature game being inactive until triggered. In this preferred form, the change in said feature game from being inactive to active may be indicated on the display. Alternatively, said displaying step comprises displaying said feature game in response to said trigger event.

Preferably, said method further comprises displaying said base game on a separate display to said display. Alternatively, said method further comprises displaying said feature game and said base game on the same display.

Preferably, said method also comprises the preferred features of the first aspect of the invention not otherwise stated above, where applicable.

According to a fourth aspect of the invention, there is provided there is provided a gaming method for an electronic gaming machine comprising a display and an electronic game controller, the method comprising the steps of:

controllably displaying game symbols for playing a game, where predetermined winning combinations of randomly selected game symbols in said game results in the award of prizes to a player, said game symbols being arranged in an array of predetermined portions;

determining the appearance of one or more special symbols in said game, said special symbols being associated with a numerical value, and where at least two special symbols appear in the same predetermined portion, increasing the value of any prize awarded upon a predetermined winning combination comprising a designated game symbol in said same predetermined portion,

wherein said prize value increasing step comprises combining the numerical values associated with said at least two special symbols and associating said prize value with said combined numerical value.

Preferably, said prize value increasing step comprises multiplying said prize value by said combined numerical value.

Preferably, where said predetermined winning combination comprises at least one additional special symbol in a different predetermined portion, said combining step comprises combining the numerical values associated with said at least two special symbols and said at least one additional special symbol. More preferably, said combining step comprises the sum of said numerical values associated with said at least two special symbols and said at least one additional special symbol. Alternatively, said combining step comprises the multiplication of said numerical values associated with said at least two special symbols and said at least one additional special symbol.

Preferably, said electronic gaming machine also comprises the preferred features of the second or third aspects of the invention not otherwise stated above, where applicable.

According to a fifth aspect of the invention, there is provided a computer system comprising a central processing unit configured for communication with an electronic gaming machine, wherein said computer system is configured to perform the method of the second or fourth aspects of the invention.

According to a sixth aspect of the invention, there is provided a computer program configured to perform the method of the second or fourth aspects of the invention.

According to a seventh aspect of the invention, there is provided a non-transitive carrier medium carrying computer executable code that, when executed on a central processing unit configured for communication with an electronic gaming machine, causes the central processing unit to perform the method of the second or fourth aspects of the invention.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to a an embodiment of the invention;

FIG. 2 is a schematic drawing of an electronic game controller for the electronic gaming machine of FIG. 1;

FIG. 3 is a schematic drawing illustrating a game played on the electronic gaming machine of FIG. 1; and

FIGS. 4 and 5 are schematic drawings illustrating another game played on the electronic gaming machine of FIG. 1.

### DETAILED DESCRIPTION OF THE VARIOUS EMBODIMENTS

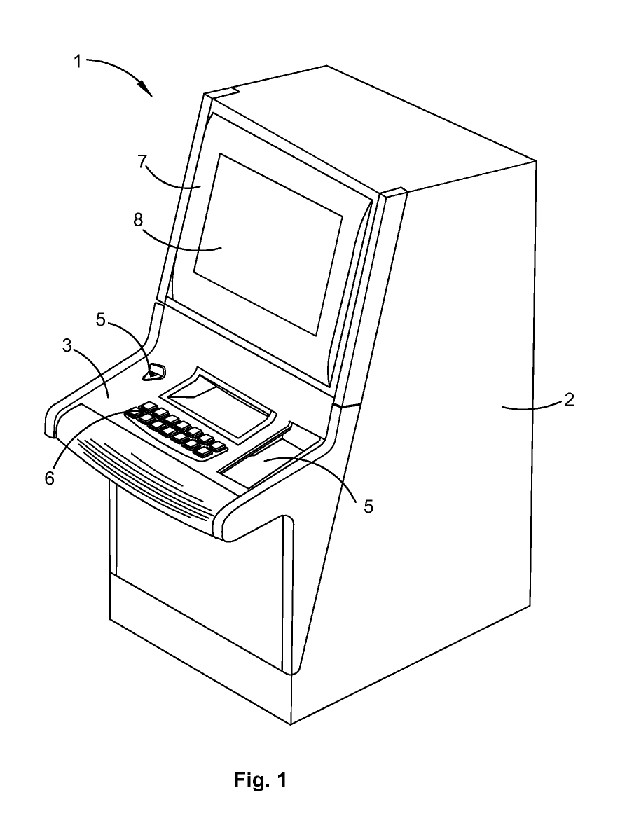

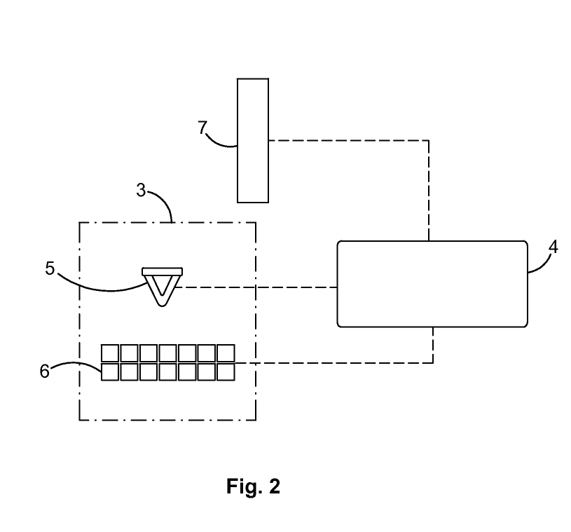

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. The electronic game controller 4 is generally in the form of a central processing unit, such as a computer, and is in electronic communication with a display in the form or a display screen 7 and various input devices on the console 3, as best shown in FIG. 2. It is also appreciated that a person skilled in the art would readily understand the location and use of the electronic game controller 4 in the electronic gaming machine 1.

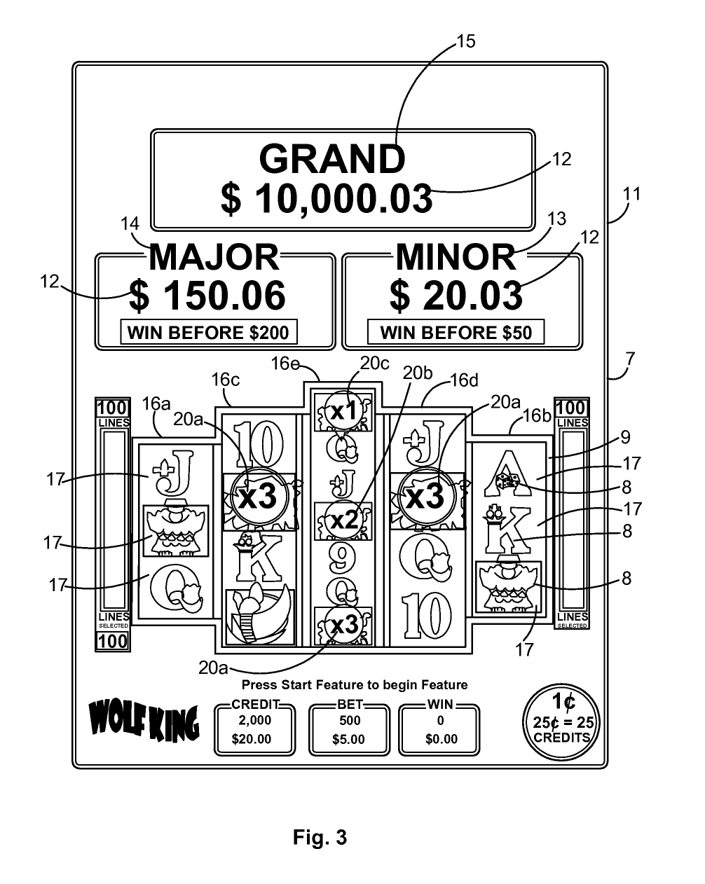

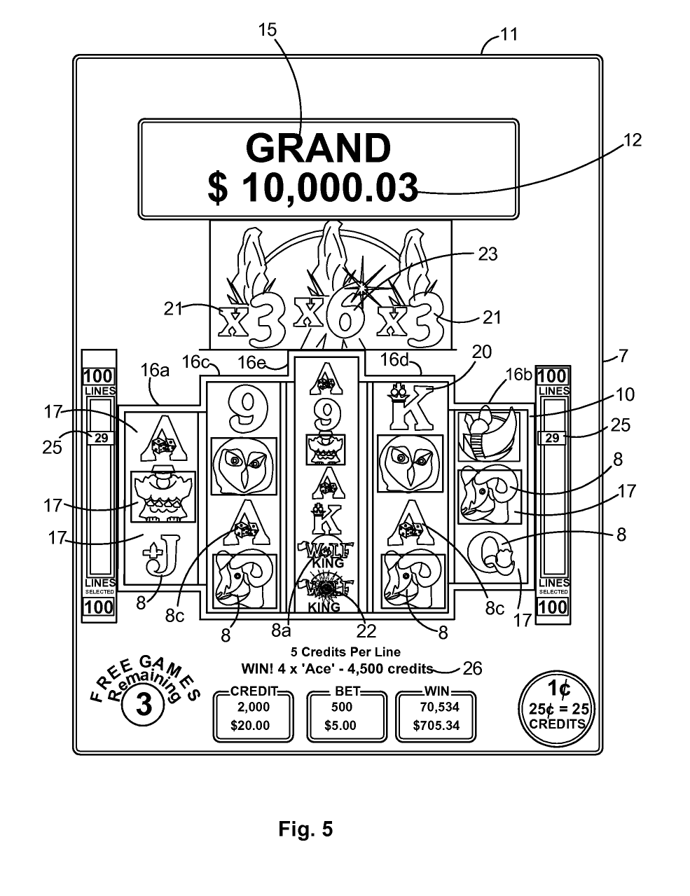

The display screen 7 is used to display game symbols 8 for playing a base or main game 9 and a feature game 10 on the electronic gaming machine 1, as best shown in FIGS. 3 and 5. A player inserts a monetary amount into the electronic gaming machine 1 and selects an initial bet to initiate play of the base game 9. In this embodiment, the invention is implemented as a game called “Wolf King”.

Another display 11 is disposed above said display 7 and comprises jackpot information comprising the monetary amounts 12 of a minor jackpot 13, major jackpot prize 14 and a grand progressive jackpot prize 15. The display 11 may either form part of the display 7 or be a separate display mounted above display 7. In other preferred forms, the jackpot prize(s) can be shared with any other games offered on the electronic gaming machine (as in multi-game gaming machined) or games offered on separate electronic gaming machines. In one preferred form, the jackpot prize comprises a mystery jackpot. That is, none of the symbols in the game trigger the jackpot; hence the triggering event is a “mystery”. By way of comparison, a standard jackpot is typically symbol driven in that a particular combination of symbols must occur in the game to trigger the standard jackpot.

As best shown in FIG. 3, in the base game 9, the game symbols 8 are arranged in the form of five columns or “reels” 16, two outer reels 16a, 16b having three visible positions or cells 17, two inner reels 16c, 16d having four cells 17 and a central or middle reel 16e having seven cells 17. The cells 17 can be considered to define the rows of each reel 16. That is, outer reels 16, 16b has three rows, inner reels 16c, 16d have four rows and the central reel 16e has seven rows. The greater number of symbols provided in the central reel 16e provides more possible combinations than would ordinarily be possible in a standard 5×3 array. Thus, the player perceives that there are a greater number of chances of obtaining a winning combination in the base game 9 and feature game 10, and so the player is more likely to keep playing the electronic gaming machine 1.

The game symbols 8 typically include picture symbols, wild symbols, scatter symbols and card symbols. Predetermined winning combinations of randomly selected game symbols 8 in the base game 9 result in the award of prizes to the player. These predetermined combinations are typically in the form of pay lines 18 that have at least one game symbol 8 from each reel 16, as best shown in FIG. 5.

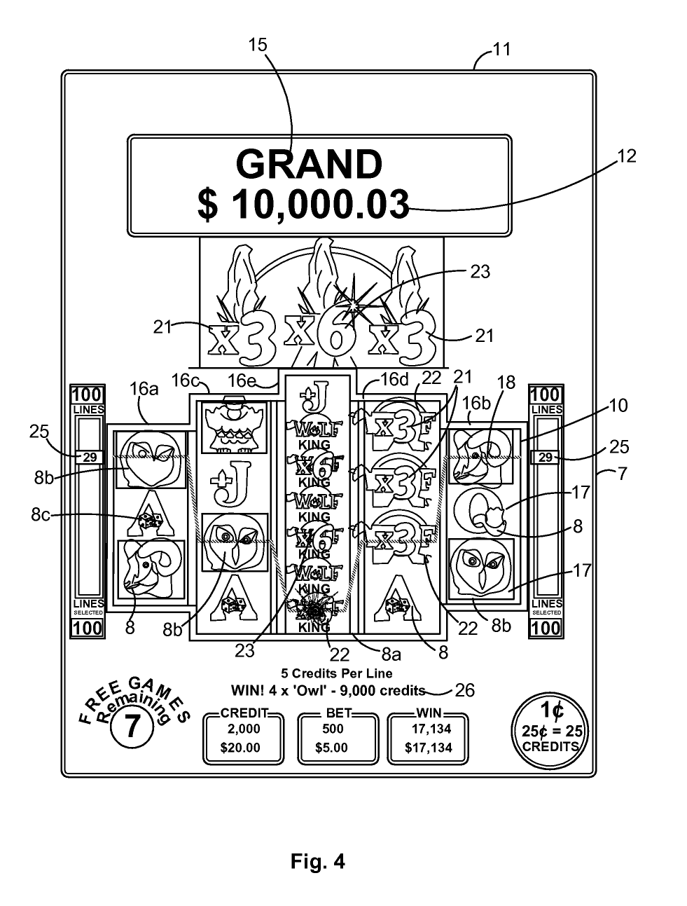

The electronic game controller 4 controls the display of the game symbols 8 in the base game 9. In response to a trigger event during play of the base game 9, the electronic game controller 4 causes the feature game 10 to appear on the display 7 for play by the player, as best shown in FIGS. 4 and 5, where corresponding features have been given the same reference numerals. In this embodiment the feature game 10 comprises game symbols 8 are arranged in the same array of reels 16 as in the base game 9. The game symbols 8 typically include picture symbols, wild symbols, scatter symbols and card symbols that are the same as the game symbols in the base game 9.

The feature game 10 comprises a predetermined number of free plays or spins of the reels 16. That is, the reels 16 in the feature game 10 are spun without requiring the player to make a bet, unlike the base game 9. In the feature game 10, predetermined winning combinations of randomly selected game symbols 8 result in the award of prizes to the player. In this embodiment, the predetermined winning combinations of game symbols 8 can award the same prizes available in the base game 9. Similarly, the electronic game controller 4 also controls the display of the game symbols 8 in the feature game 10.

Operation of this embodiment of the invention will now be described in more detail with reference FIGS. 3 to 5. The player initially makes a bet using vending slots 5 to initiate play of the base game 9 and the electronic game controller 4 causes the reels 16 to appear to visibly rotate or “spin”, and randomly display the game symbols 8. The initial bet involves the player selecting the number of pay lines 18 that are to be played. For example, the player can bet or wager 50 credits to play 10 pay lines or 200 credits to play the maximum number of 50 pay lines. Also, the player can make any additional side bets or ante-bets to access additional features in the base game, such as increasing the number of winning combinations in the base game.

After the reels 16 stop spinning, the controller 4 determines whether there are any predetermined winning combinations of the game symbols 8 appearing in any player-selected pay lines, such as a two of a kind, three of a kind, four of a kind or five of a kind. It will be appreciated that other winning combinations of game symbols 8 can also be provided. If there is a predetermined winning combination present in the base game 9, the electronic gaming machine 1 enters a winning game state and awards a prize according to the displayed predetermined winning combination.

The electronic game controller 4 determines the appearance of special symbols in the form of the multiplier scatter symbols 20 in both the base game 9 and the feature game 10, typically through a random determination. However, it will be appreciated that this determination need not be totally random as the electronic game controller 4 may switch to a reel strip having a greater probability of a multiplier symbol 20 appearing where the feature game 10 has not be triggered for a predetermined number of plays of the base game 9.

In this embodiment, there are three different types of multiplier symbols 20, each of which are associated with different numerical values. For example, multiplier symbol 20a takes the form of a “×3” symbol to indicate its association with the number 3. Similarly, multiplier symbol 20b takes the form of a “×2” symbol to indicate its association with the number 2. Finally, multiplier symbol 20c takes the form of a “×1” symbol to indicate its association with the number 1.

The multiplier symbols 20 act as trigger symbols to activate or trigger the feature game 10. As best shown in FIG. 3, three “×3” symbols 20b have appeared on the reels 16c, 16d, 16e, and in response the electronic game controller 4 causes the display of the feature game 10, as best shown in FIGS. 4 and 5. This causes the multiplier symbols 20 to be associated with the respective reels 16 in the feature game 10 that correspond to the reels of the base game 9 in which the multiplier symbols 20 appeared when the feature game was triggered. Thus, in FIG. 3, the “×3” symbol appeared in the inner reels 16c and 16d of the base game 9 when the feature game 10 was triggered. As a consequence, the ×3 multiplier symbol 20b is associated with reels 16c and 16d in the feature game 10, and this is indicated by the green “×3” images 21 in display 11 disposed above reels 16c and 16d. The alignment of the “×3” images 21 with reels 16c and 16d conveys to the player the association of the “×3” multiplier symbol 20b with the inner reels.

The association of the ×3 multiplier with reels 16c and 16d affects the outcome of the free spins in the feature game 10. Where a predetermined winning combination appears that has a designated game symbol in one of the associated reels 16c or 16d, the value of the prize awarded based on that winning combination is multiplied by 3, being the associated numerical value of the “×3” multiplier symbol 20a.

The designated game symbol can be selected from any one of the game symbols 8 or be a new symbol entirely. In this embodiment, the designated symbol is a wild card game symbol 22 that has the words “Wolf King” and a glowing wolf paw image, as best shown in FIG. 5, and hereinafter referred to as the glowing paw symbol. The glowing paw symbol 22 should be distinguished from a similar wild card game symbol 8a that also has the words “Wolf King” and a plain wolf paw image, as best shown in FIG. 4.

Furthermore, if the predetermined winning combination uses more than one designated symbol, for example, a glowing paw symbol 22 appears in both reels 16c and 16d, then the value of the prize awarded based on the predetermined combination is multiplied by a combination of the associated numerical values of the multiplier symbol 20. In this embodiment, the combination is the sum of the associated numerical values and so in the example the prize is multiplied by 6, the “×3” multiplier symbols 20a being added to produce a “×6” multiplier.

The association of the multiplier symbols 20 with the reels 16 in the feature game 10 is not limited to the “×3” multiplier symbols 20a that trigger the feature game. In FIG. 3, the “×3” multiplier symbol 20a, “×2” multiplier symbol 20b and “×1” multiplier symbol 20c appeared in the central reel 16e of the base game 9 when the feature game 10 was triggered. These multiplier symbols 20a, 20b, 20c are also associated with the central reel 16e of the feature game 10 corresponding to the central reel of the base game 9. Since more than one multiplier symbol 20 has appeared in the same reel 16e when the feature game 10 was triggered, the numerical values associated with the multiplier symbols 20a, 20b, 20c are combined provide a cumulative multiplier for the value of any prize based on a predetermined combination that uses the glowing paw symbol 22 in the central reel 16e. In this embodiment, the combination is the sum of the associated numerical values and so in this case the prize is multiplied by 6, the “×3” multiplier symbol 20a, “×2” multiplier symbol 20b and “×1” multiplier symbol 20c being added to produce a “×6” multiplier. This cumulative “×6” multiplier is indicated to the player in additional display 11 via a red “×6” image 23 that is disposed above or aligned with the central reel 16e.

In addition, the combined value is displayed in the feature game 10 when the ×6 multiplier is applied to a winning combination. This is typically done by superimposing the “×6” image 23 over the glowing paw symbol 22 wherever it appears in the central reel 16e. This indication is also used for the other associated reels. That is, the glowing paw symbol 22 also has the “×3” image 21 superimposed where it appears in the reels 16c, 16d associated with the ×3 multiplier. The “×3” and “×6” multiplier images 21 and 23 and/or the glowing paw symbol 22 can be animated to further emphasise this indication to the player.

For all ten free spins in the feature game 10, the “×3” multiplier is in effect for winning combinations containing the glowing paw symbol 22 in inner reels 16c, 16d and the “×6” multiplier is in effect for winning combinations containing the glowing paw symbol 22 in the central reel 16e.

The conclusion of a third spin or play of the feature game 10 is illustrated in FIG. 4, where the “×3” multiplier is in effect for winning combinations containing the glowing paw symbol 22 in inner reels 16c, 16d and the “×6” multiplier is in effect for winning combinations containing the glowing paw symbol 22 in the central reel 16e. In this spin, three glowing paw symbols 22 have appeared in inner reel 16d, while three glowing paw symbols 22 have appeared in central reel 16e. The application of the multipliers is indicated by the “×3” and “×6” images 21 and 23 being superimposed over the glowing paw symbols 22. This highlights the multiplier effect to the player and thus increases his or her excitement. The glowing paw symbols 22 are distinguished from the similar wild card symbols 8a due to the “×3” and “×6” images 21 and 23. The images 21, 23 flash intermittently to further indicate to the player the importance of the glowing paw symbols 22 and the associated multiplier effect.

There is a predetermined winning combination of the selected pay line 18 numbered 29, as indicated by the pay line number appearing at positions 25 adjacent the beginning and end of the pay line. Since the winning combination contains one glowing paw symbol 22 from the central reel 16e and one glowing paw symbol 22 from the inner reel 16d, the numerical values of these multiplier symbols are combined to increase the value of the prize awarded based on the winning combination. Again, in this embodiment, the combination is the sum of the numerical values and so the prize is multiplied by 9, the “×6” multiplier and “×3” multiplier being added to produce an ×9 multiplier. This increase in cumulative multiplier for the prize is indicated to the player via a congratulatory message 26 displayed below the reels 16 informing the player the details of the winning combination and the prize awarded. In this case, the win is identified as “4 Owls”, comprising two Owl symbols 8b in outer reel 16a and inner reel 16c, one glowing paw symbol 22 from the central reel 16e and one glowing paw symbol 22 from the inner reel 16d. Both the multiplier symbols 20a, 20d act as wild card symbols. Thus, the increased value of the prize increases the player's excitement and enhances his or her interest in playing the electronic gaming machine 1.

The conclusion of a subsequent spin or play of the feature game 10, being the seventh spin, is illustrated in FIG. 5, where corresponding features have been given the same reference numerals. In this spin, one of the glowing paw symbols 22 has appeared in central reel 16c while three ace symbols 8c have appeared in reels 16a, 16c and 16d, which confers a predetermined winning combination of four ace symbols (the glowing paw symbol 22 being a wild or substitute symbol acts as an ace symbol) on the same selected pay line 18 numbered 29, as indicated by the pay line number appearing at positions 25 adjacent the beginning and end of the pay line. Accordingly, the win is multiplied by 6 under the multiplier effect in force for the feature game 10. For the purposes of clarity the “×6” image 23 has been omitted to more clearly illustrate the glowing paw symbol 22. However, it will be appreciated that the “×6” image 23 would be ordinarily superimposed over the glowing paw symbol as the “×6” multiplier is in effect. Also, a congratulatory message 26 is displayed below the reels 16 informing the player the details of the winning combination (effectively 4 ace symbols) and the prize awarded.

Once all the free spins have been played in the feature game 10, the electronic game controller 4 returns the electronic gaming machine 1 to the base game 9. The electronic gaming machine 1 will await the trigger event to occur in a play of the base game 9 before proceeding to the feature game 10.

In one preferred form, the invention is implemented in only a base game, rather than a base game with a feature game. In this preferred form, the base game would generally operate as described above in relation to FIGS. 3 to 5, but the multiplier symbols would take effect in a subsequent play of the base game, typically the next spin or play of the base game 9. Likewise, the invention can be implemented as a feature game only, so that the multiplier symbols would take effect in a subsequent play of the feature game 10. It will be appreciated that the subsequent play need not be a successive play, but could be later in a sequence of plays of the base game.

In another preferred form, the plays or spins need not be free as described in the preferred embodiment. Rather, the player may be required to make a further bet in order to play the spins in which the reels are selected and reselected with a new reel. Alternatively, where the invention is implemented in a base game 9, the player makes a bet for each spin as in a conventional base game.

While the preferred embodiment has been described as using a wild symbol as the designated symbol, it will be appreciated that any other game symbol can be used as the designated symbol, including the multiplier trigger symbols 20. Also, in other preferred forms, where multiplier symbols 20 appear in the same reel 16 a new cumulative symbol displaying the combined value can be used as the designated symbol. For example, instead of displaying the “×6” image 23 being superimposed over the glowing paw symbol 22, a new cumulative “×6” multiplier symbol replaces the glowing paw symbol 22 in the central reel 16e. In a further variation, the cumulative “×6” multiplier symbol can be replaced with each of the “×3” multiplier symbol 20a, “×2” multiplier symbol 20b and “×1” multiplier symbol 20c so that these multiplier symbols 20a, 20b, 20c become designated symbols in a winning combination. Thus, the appearance of any of these multiplier symbols 20a, 20b, 20c in central reel 16e as part of a winning combination would confer the cumulative “×6” multiplier. In this case, the “×6” image 23 in display 11 would indicate that the “×6” multiplier is in effect.

The preferred embodiment has also been described as having the special symbol associated with the same reel in which is initially appears to cause the multiplier effect. That is, the “×3” multiplier symbol 20a, “×2” multiplier symbol 20b and “×1” multiplier symbol 20c are each associated with the reels 16 in the feature game 10 that they respectively appeared initially in the base game 9. However, it will be appreciated that the special symbol could be associated with another reel in the feature game 10 that is different to the reel in which it first appears in the base game 9 when the feature game is triggered.

Although the preferred embodiment has been described as increasing the prize value by a multiple of the numerical values associated with the multiplier symbols, it will be appreciated that the invention also includes other types of associations between the prize value increase and the numerical values. For example, the prize value could be increased by simply adding the numerical value to the prize value. Another type of association involves increasing the prize value by replacing or supplementing one of the digits of the prize value. For example, a numerical value of 3 is associated with a special symbol and a prize value of, say, 250 credits could be increased by adding the number 3 into the prize value number to create increased prize values of 2503, 2530, 2350 or 3250 credits. Using the same example, the number 3 could replace the first digit to create an increased prize value of 350 credits.

Also, the predetermined portions of the array that are associated with the special symbol are not limited to reels or columns, but could take other forms, such as rows. In the case of non-rectangular arrays (i.e. arrays that do not comprise rows and columns), the predetermined portions can be an identifiable group of the array. For example, where the array is circular, the predetermined portions can take the form of pie-shaped slices or wedges. Furthermore, the predetermined portions could be similar to pay lines in a rectangular array.

While the same game format is essentially used across the base game 9 and feature game 10, it will be appreciated that the game format may vary across both games. For example, the base game 9 may be a wheel-type game or a four reel game and the feature game 10 may be a standard five reel game. Similarly, the base game 9 and feature game 10 may each have different game symbols, game rules and pay tables that are unique to each game.

Also, in another preferred form, there is no need for a trigger event in the form of the appearance of a predetermined number of trigger symbols. Instead, the electronic game controller 4 can internally determine when to permit increases in the value of prizes based on winning combinations comprising multiplier symbols 20 in the same reel and/or in the same pay line 18. One way to implement this preferred form is for the electronic game controller 4 to internally generate a random number and checks if it is a predetermined number or within a predetermined range of numbers that will initiate selection of reels that guarantee the appearance of special symbol(s). For example, the predetermined range of numbers could be the range of numbers between 1 and 10 and the electronic game controller 4 internally generates a random number between 1 and 100. If the generated number is any one of numbers 1 to 10, then this results in the electronic game controller 4 permitting the increase in prize value for winning combinations comprising multiplier symbols 20 in the same reel and/or in the same pay line 18.

While the embodiment of the invention has been described in relation to a base game and a feature game, it will be appreciated that the invention could include an additional feature game that is triggered by specific trigger symbols appearing in the feature game 10. Also, the additional feature game may also have trigger symbols that trigger further feature game in a cascading fashion. These additional and further feature games could have the same game play elements as the feature game 10 or be different feature games entirely.

Also, in a further preferred form, the player can selectively stop spinning of the reels 16 in the feature game 10 to increase player interaction. Furthermore, the player can start spinning of the reels 16 in the feature game 10 to further enhance player interaction.

In other preferred forms, the base game 9 and feature game 10 are displayed on separate screens, rather than being sequentially replaced on a single screen 7. Alternatively, the base game 9 and feature game 10 are displayed together on the screen 7, with suitable animation or highlighting being used to indicate that the feature game 10 has become active.

In another preferred form, the video screen 7 is a touch screen for use in addition to the player-actuatable buttons 6 so as to enable the player to select various features, such as making monetary bets for the game and responding to any messages or requests issued on the electronic gaming machine 1 by the electronic game controller 4. In this case, the player may control when the reels 16 start spinning and stop spinning in any of the base game 9 and feature game 10 by simply touching the relevant reel 16.

In yet a further preferred form, the base game 9 employs separate trigger symbols to the multiplier symbols 20. In this case, any multiplier symbols that appear on the reels at the time the trigger symbols appear to activate the feature game 10 will be associated with their respective reels 16 and operate in a similar manner as described in relation to FIGS. 3 to 5 above.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way the invention can be implemented in various ways on an electronic gaming machine. In a further aspect, the invention includes a computer system configured comprising a central processing unit configured for communication with an electronic gaming machine to perform the invention. In a yet another aspect, the invention includes a non-transitive carrier medium carrying computer executable code that, when executed on a central processing unit configured for communication with an electronic gaming machine, causes said central processing unit to perform the invention. In this case, the non-transitive carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of not have a specific trigger event can be readily combined with the feature of using a new cumulative multiplier symbol instead of the wild card symbol as the designated symbol in the feature game.

By providing special symbols with associated numerical values that are associated with predetermined portions of the array and combine to provide increases in the value of prizes based on winning combinations comprising a designated symbol in the predetermined portion, the invention increases player excitement and thus interest in the feature game, thus encouraging the player to continue playing the same electronic gaming machine. Similarly, providing special symbols with associated numerical values that combine when the special symbols appear in the same predetermined portion to provide increases in the value of prizes based on winning combinations comprising a designated symbol in the same predetermined portion, the invention also increases player excitement and thus interest in the feature game, thus encouraging the player to continue playing the same electronic gaming machine. Furthermore, the indication of the combined numerical value, through the appearance of the special symbols or a special symbol associated with the combined numerical value, enhances the player's anticipation during plays or spins of the feature game, as the player knows that the appearance of such special symbols in a winning combination significantly increases the value of the awarded prize. All these advantages of the invention result in the player being more likely to retain interest in continuing to play the same electronic gaming machine. Furthermore, since the electronic game controller controls operation of the base game and feature game, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a display for displaying game symbols for playing a game, where predetermined winning combinations of randomly selected game symbols award prizes to a player and said game symbols are arranged into an array, and
an electronic game controller for controlling the display of game symbols on the display,
wherein said electronic game controller determines the appearance of one or more special symbols in said game, said special symbols being associated with a numerical value, and
wherein the appearance of a first special symbol in a first play of said game causes said electronic game controller to associate said first special symbol with a predetermined portion of said array for one or more subsequent plays of said game such that said electronic game controller increases the value of any prize awarded upon a predetermined winning combination appearing in said one or more subsequent plays, said predetermined winning combination comprising a designated game symbol in said predetermined portion, said increase being associated with the numerical value associated with said first special symbol.

2. The electronic gaming machine of claim 1, wherein said increase is a multiple of said numerical value associated with said first special symbol.

3. The electronic gaming machine of claim 1, wherein the appearance of a second special symbol in said first play causes said electronic game controller to associate said second special symbol with a second predetermined portion for said subsequent plays such that said prize is increased where said predetermined winning combination comprises said designated symbol appearing in said second predetermined portion, said increase being associated with a combined value of the numerical values associated with said first and second special symbols.

4. The electronic gaming machine of claim 3, wherein said increase is a multiple of said combined value.

5. The electronic gaming machine of claim 3, wherein said combined value is the sum of said numerical values associated with said first and second special symbols.

6. The electronic gaming machine of claim 3, wherein said combined value is the multiplication of said numerical values associated with said first and second special symbols.

7. The electronic gaming machine of claim 3, wherein said second predetermined portion is the same as said predetermined portion.

8. The electronic gaming machine of claim 3, wherein said second predetermined portion is different to said predetermined portion.

9. The electronic gaming machine of claim 3, wherein said game symbols are arranged in an array of predetermined columns, said predetermined portion comprising a first column of said predetermined columns and said second predetermined portion comprising a second column of said predetermined columns.

10. The electronic gaming machine of claim 3, wherein the association of said second special symbol with said second predetermined portion is indicated on said display during said subsequent plays of said game.

11. The electronic gaming machine of claim 1, wherein said designated game symbol comprises at least one of said game symbols and said first special symbols.

12. The electronic gaming machine of claim 1, wherein said designated game symbol may also act as at least one of a replacement symbol, a wild card symbol, a scatter symbol, bonus prizes, collector symbols, a win multiplier, wild multipliers, bonus wilds, random wild symbols, progressive symbols, bonus credits and jackpot symbols.

13. The electronic gaming machine of claim 1, wherein a third special symbol appears in said predetermined portion in said first play, said numerical values associated with said third special symbol and said first special symbol are combined into a new combined value that is associated with said predetermined portion and said increase is a multiple of said new combined value.

14. The electronic gaming machine of claim 13, wherein said new combined value is associated with a new special symbol that is selectable for appearing in said array for said subsequent plays of said game.

15. The electronic gaming machine of claim 13, wherein said new combined value is the sum of said numerical values associated with said first and third special symbols.

16. The electronic gaming machine of claim 13, wherein said new combined value is the multiplication of said numerical values associated with said first and third special symbols.

17. The electronic gaming machine of claim 1, wherein said first special symbol appears in said predetermined portion in said first play.

18. The electronic gaming machine of claim 1, wherein said game symbols are arranged in an array of predetermined columns and said predetermined portion comprises a first column of said predetermined columns.

19. The electronic gaming machine of claim 1, wherein said predetermined portion displays a number of game symbols greater than the number of game symbols displayed in at least one other predetermined portion of said array.

20. The electronic gaming machine of claim 1, wherein the association of said first special symbol with said predetermined portion is indicated on said display during said subsequent plays of said game.

21. The electronic gaming machine of claim 1, wherein said game comprises a base game and a feature game of said electronic gaming machine, wherein said first play comprises a play of said base game and said subsequent plays comprise plays of said feature game.

22. The electronic gaming machine of claim 1, wherein said special symbol also acts as another type of game symbol.

23. An electronic gaming machine comprising:
a display for displaying game symbols for playing a game, where predetermined winning combinations of randomly selected game symbols award prizes to a player and said game symbols are arranged in an array of predetermined portions, and
an electronic game controller for controlling the display of game symbols on the display,
wherein said electronic game controller determines the appearance of one or more special symbols in said game, said special symbols being associated with a numerical value, and
where at least two special symbols appear in the same predetermined portion, said electronic game controller increases the value of any prize awarded upon a predetermined winning combination comprising a designated game symbol in said same predetermined portion, said increase being associated with a combined value of the numerical values associated with said at least two special symbols.

24. The electronic gaming machine of claim 23, wherein said increase is a multiple of said combined value.

25. The electronic gaming machine of claim 23, wherein said combined value is the sum of said numerical values associated with said at least two special symbols.

26. The electronic gaming machine of claim 23, wherein said combined value is the multiplication of said numerical values associated with said at least two special symbols.

27. The electronic gaming machine of claim 23, wherein a new special symbol associated with said combined value becomes selectable for appearing in one or more subsequent plays of said game.

28. The electronic gaming machine of claim 28, wherein said new special symbol is associated with said same predetermined portion such that said new special symbol is selectable for appearing in said column in said one or more subsequent plays of said game.

29. The electronic gaming machine of claim 23, wherein said predetermined winning combination comprises at least one additional special symbol in a different predetermined portion to said same predetermined portion, said increase being associated with a combination of said combined value and the numerical value associated with said at least one additional special symbol.

30. The electronic gaming machine of claim 29, wherein said increase is a multiple of said combination.

31. The electronic gaming machine of claim 29, wherein said combination is the sum of said numerical values associated with said at least two special symbols and said at least one additional special symbol.

32. The electronic gaming machine of claim 29, wherein said combination is the multiplication of said numerical values associated with said at least two special symbols and said at least one additional special symbol.

33. The electronic gaming machine of claim 23, wherein said designated game symbol comprises at least one of said game symbols and said special symbols.

34. The electronic gaming machine of claim 23, wherein said designated game symbol also acts as at least one of a replacement symbol, a wild card symbol, a scatter symbol, bonus prizes, collector symbols, a win multiplier, wild multipliers, bonus wilds, random wild symbols, progressive symbols, bonus credits and jackpot symbols.

35. A gaming method for an electronic gaming machine comprising a display and an electronic game controller, the method comprising the steps of:
controllably displaying game symbols for playing a game, where predetermined winning combinations of randomly selected game symbols in said game results in the award of prizes to a player, said game symbols being arranged in an array;
determining the appearance of one or more special symbols in said game, said special symbols being associated with a numerical value,
associating a first special symbol appearing in a first play of said game with a predetermined portion of said array for one for one or more subsequent plays of said game, and
increasing the value of any prize awarded upon a predetermined winning combination appearing in said one or more subsequent plays, said predetermined winning combination comprising a designated game symbol in said predetermined portion,
wherein said prize value increasing step comprises associating said prize value with the numerical value associated with said first special symbol.

36. The gaming method of claim 35, wherein said prize increasing step further comprises multiplying said prize value by the numerical value associated with said first special symbol.

37. The gaming method of claim 35, wherein said associating step further comprises associating a second special symbol appearing in said first play with a second predetermined portion for said subsequent plays, and where said predetermined winning combination comprises said designated symbol appearing in said second predetermined portion, said prize value increasing step further comprises the step of combining the numerical values associated with said first and second special symbols to produce a combined value and associating said prize value with said combined value.

38. The gaming method of claim 37, wherein said prize increasing step further comprises multiplying said prize value by said combined value.

39. The gaming method of claim 37, wherein said combining step comprises the sum of said numerical values associated with said first and second special symbols.

40. The gaming method of claim 37, wherein said combining step comprises the multiplication of said numerical values associated with said first and second special symbols.

41. The gaming method of claim 35, wherein a third special symbol appears in said predetermined portion in said first play, said prize value increasing step further comprising the step of combining the numerical values associated with said first and third special symbols to produce a new combined value that is associated with said predetermined portion and multiplying said prize by said new combined value.

42. The gaming method of claim 41, wherein said new combined value is the sum of said numerical values associated with said first and third special symbols.

43. The gaming method of claim 41, wherein said new combined value is the multiplication of said numerical values associated with said first and third special symbols.

44. The gaming method of claim 35, wherein said associating step further comprises associating said first special symbol when it appears in said predetermined portion.

45. The gaming method of claim 35, further comprising the step of displaying a number of game symbols in said predetermined portion greater than the number of game symbols displayed in at least one portion of said array.

46. The gaming method of claim 35, wherein said associating step further comprises indicating the association of said first special symbol with said predetermined portion on said display during said subsequent plays of said game.

47. A gaming method for an electronic gaming machine comprising a display and an electronic game controller, the method comprising the steps of:
controllably displaying game symbols for playing a game, where predetermined winning combinations of randomly selected game symbols in said game results in the award of prizes to a player, said game symbols being arranged in an array of predetermined portions;
determining the appearance of one or more special symbols in said game, said special symbols being associated with a numerical value, and
where at least two special symbols appear in the same predetermined portion, increasing the value of any prize awarded upon a predetermined winning combination comprising a designated game symbol in said same predetermined portion,
wherein said prize value increasing step comprises combining the numerical values associated with said at least two special symbols and associating said prize value with said combined numerical value.

48. The gaming method of claim 47, wherein said prize value increasing step comprises multiplying said prize value by said combined numerical value.

49. The gaming method of claim 47, wherein said predetermined winning combination comprises at least one additional special symbol in a different predetermined portion, and said combining step comprises combining the numerical values associated with said at least two special symbols and said at least one additional special symbol.

50. The gaming method of claim 49, wherein said combining step comprises the sum of said numerical values associated with said at least two special symbols and said at least one additional special symbol.

51. The gaming method of claim 49, wherein said combining step comprises the multiplication of said numerical values associated with said at least two special symbols and said at least one additional special symbol.

52. A computer system comprising a central processing unit configured for communication with an electronic gaming machine, wherein said computer system is configured to perform the method of claim 35.

53. A computer program configured to perform the method of claim 35.

54. A non-transitive carrier medium carrying computer executable code that, when executed on a central processing unit configured for communication with an electronic gaming machine, causes said central processing unit to perform the method of claim 35.

55. A computer system comprising a central processing unit configured for communication with an electronic gaming machine, wherein said computer system is configured to perform the method of claim 47.

56. A computer program configured to perform the method of claim 47.

57. A non-transitive carrier medium carrying computer executable code that, when executed on a central processing unit configured for communication with an electronic gaming machine, causes said central processing unit to perform the method of claim 47.
